(19) United States
(12) Patent Application Publication
(10) Pub. No.: US 2026/0225166 A1
(43) Pub. Date: Aug. 6, 2026

(54) PIPE SPLITTER AND METHOD

(71) Applicant: TT Technologies, Inc., Aurora, IL (US)

(72) Inventors: John A. Olander, Clayton, WI (US); Jeffrey Norman Dauderman, Oswego, IL (US)

(73) Assignee: TT Technologies, Inc., Aurora, IL (US)

(21) Appl. No.: 19/462,202

(22) Filed: Jan. 28, 2026

Related U.S. Application Data
(60) Provisional application No. 63/752,000, filed on Jan. 31, 2025.

(51) Int. Cl. B23D 21/02

(52) U.S. Cl. CPC B23D 21/02

(57) ABSTRACT

A pipe splitter and associated systems and methods are disclosed. Pipe splitters are shown that include replaceable cutter blades and redundant cutter blades. Configurations and methods for replacing cutter blades are shown. Devices and methods of splitting pipe and removing pipe from the ground are further shown.

### CLAIM OF PRIORITY

This patent application claims the benefit of priority, under 35 U.S.C. § 119(e), to U.S. Provisional Patent Application Serial No. 63/752,000 entitled “PIPE SPLITTER AND METHOD,” filed on Jan 31, 2025, which is hereby incorporated by reference herein in its entirety.

### TECHNICAL FIELD

Embodiments described herein generally relate to underground pipe replacement tools and associated methods.

### BACKGROUND

Trenchless pipe bursting and pipe removal technologies have revolutionized underground infrastructure rehabilitation and replacement over the past several decades. Traditional open-cut methods of pipe replacement require extensive excavation, causing significant surface disruption and increased costs. In contrast, trenchless methods allow for the replacement or removal of existing underground pipes while minimizing surface disturbance.

Pipe bursting, involves fragmenting an existing pipe while simultaneously pulling a new pipe into place. This process utilizes a bursting head that breaks the old pipe outward while a new pipe is drawn through the void. The technique has proven particularly effective for upgrading undersized utility lines, as the new pipe can be of equal or larger diameter than the existing pipe.

The removal of aging underground pipes, particularly those containing hazardous materials like lead, has become increasingly critical for public health and infrastructure modernization. Various pipe removal techniques have been developed, including pipe extraction methods that pull the existing pipe from the ground while leaving minimal environmental impact.

Improved methods and tools to streamline the replacement process, reduce associated costs, and ensure the long-term safety and reliability of water and other piping systems are desired. Pipe replacement devices, splitting devices, and methods described in the present disclosure address these, and other technical challenges.

### BRIEF DESCRIPTION OF THE DRAWING

The following description and the drawings sufficiently illustrate specific embodiments to enable those skilled in the art to practice them. Other embodiments may incorporate structural, logical, electrical, process, and other changes. Portions and features of some embodiments may be included in, or substituted for, those of other embodiments. Embodiments set forth in the claims encompass all available equivalents of those claims.

FIG. 1 shows a cable puller in accordance with some example embodiments.

FIG. 2A shows a pipe splitter in accordance with some example embodiments.

FIG. 2B shows an end view of the pipe splitter from FIG. 2A in accordance with some example embodiments.

FIG. 2C shows a replaceable cutter blade in accordance with some example embodiments.

FIG. 2D shows a cross section view of a pipe splitter in accordance with some example embodiments.

FIG. 3A shows a stage of assembly of a pipe splitter in accordance with some example embodiments.

FIG. 3B shows another stage of assembly of the pipe splitter in accordance with some example embodiments.

FIG. 3C shows another stage of assembly of the pipe splitter in accordance with some example embodiments.

FIG. 3D shows another stage of assembly of the pipe splitter in accordance with some example embodiments.

FIG. 4A shows a portion of a pipe splitter in accordance with some example embodiments.

FIG. 4B shows a pipe splitter in a splitting operation in accordance with some example embodiments.

FIG. 4C shows a cross section view of a pipe splitter in a splitting operation in accordance with some example embodiments.

FIG. 4D shows a split pipe in accordance with some example embodiments.

FIG. 5A shows a pipe splitter in a splitting operation in accordance with some example embodiments.

FIG. 5B shows the pipe splitter in another part of a splitting operation in accordance with some example embodiments.

FIG. 6 shows an example method diagram for use of a pipe splitter in accordance with some example embodiments.

FIG. 7 shows an example method diagram for pipe splitting in accordance with some example embodiments.

### DESCRIPTION OF EMBODIMENTS

The following description and the drawings sufficiently illustrate specific embodiments to enable those skilled in the art to practice them. Other embodiments may incorporate structural, logical, electrical, process, and other changes. Portions and features of some embodiments may be included in, or substituted for, those of other embodiments. Embodiments set forth in the claims encompass all available equivalents of those claims.

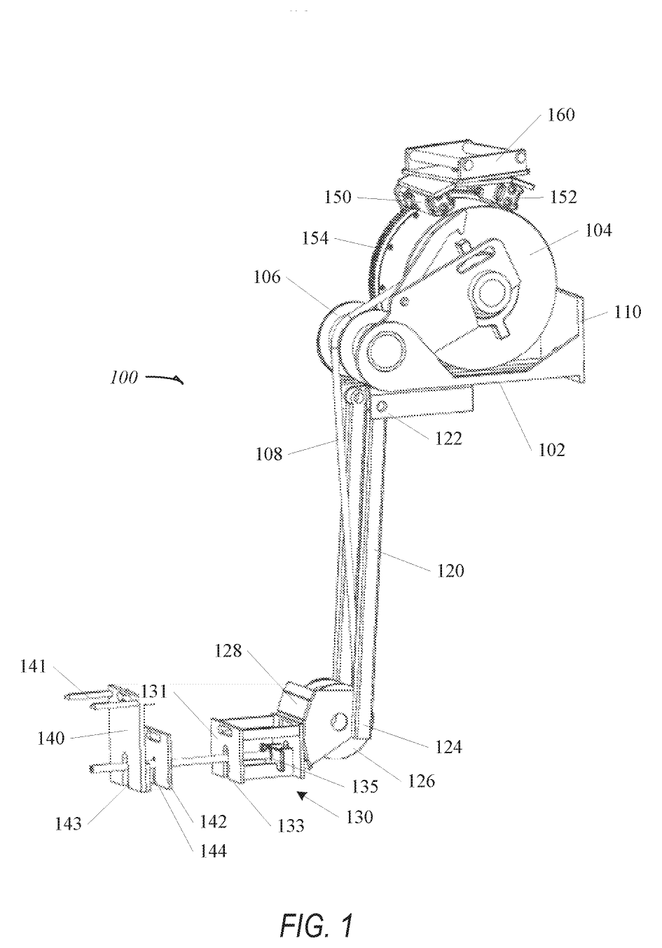

FIG. 1 shows a pipe replacement device 100 according to one example. Although the pipe replacement device 100 is shown as an example of a cable puller, the invention is not so limited. Other cable pullers, such as winches, cyclic pullers, etc. may be used to pull pipe splitters as described below. The device 100 can be used to pull a cable with a splitting tool through the ground to split a pipe and either remove the split pipe from the ground, or leave the split pipe in the ground with a replacement pipe pulled into the space previously occupied by the split pipe.

The pipe replacement device 100 includes a device frame 102. A winch drum 104 is shown coupled to a pair of driving motors 150, 152. Although a pair of motors are shown in the example of FIG. 1, the invention is not so limited. A single driving motor, or more that two motors are also within the scope of the present disclosure. Examples of driving motors 150, 152 include, but are not limited to, hydraulic motors, electric motors, etc. In the example shown, the driving motors 150, 152 engage teeth 154 located on a rim of the winch drum 104. Although teeth 154 are shown engaging corresponding teeth on drive gears of driving motors 150, 152, the invention is not so limited. Other drive configurations, such as a chain drive, belt drive, etc. are within the scope of the invention.

A mount 160 is shown coupled to the pipe replacement device 100 in FIG. 1. In one example, the mount 160 is adapted to attach to an arm of a ground working vehicle. An example of a ground working vehicle includes a backhoe arm. Although a backhoe is used as an example, the invention is not so limited. Other ground working vehicles include landscaping vehicles, skid steer vehicles, cranes, etc. The pipe replacement device 100 is made from metal, and may be heavy for a user to carry to a pit for a pipe extraction or bursting operation. The ability to move the pipe replacement device 100 using a ground working vehicle eases a burden on the user.

A first reaction plate 110 is shown coupled to the device frame 102. The first reaction plate 110 defines a first in-line pipe pulling orientation. A boom 120 is further shown coupled to the device frame 102, the boom 120 defines a second, optional pulling orientation, different from the first in-line pipe pulling orientation. In the example of FIG. 1, a cable 108 is shown extending from the winch drum 104, over a guide pulley 106 and adjacent to the boom 120. In the configuration of FIG. 1, the cable is being utilized in the second pulling orientation, and is not utilizing the first reaction plate 110.

The boom 120 is shown coupled to the frame 102 at a proximal end by a hinge 122 that facilitates folding the boom 120 underneath the frame 102 when not in use. FIG. 1 further shows components at a distal end 124 of the boom 120. A distal pulley 126 is included at the distal end 124, and a second reaction plate 128. In the example of FIG. 1, the second reaction plate 128 is arced, to facilitate different angles of contact with a side of a pit, or intervening structures located within a pit.

A pipe splitting fixture 130 is shown in FIG. 1 located adjacent to the second reaction plate 128. A soil stake plate 140 is shown spaced apart from the pipe splitting fixture 130. A number of soil stakes 141 are shown, that may be used to hold the soil stake plate 140 in place directly against soil in a side of a pit. A vertical slot 143 is included in the soil stake plate 140 to facilitate side loading of the soil stake plate 140 onto the cable 108. In operation, it is advantageous to be able to assemble components, such as the soil stake plate 140, onto the cable 108 laterally, or over a side surface of the cable 108. This allows the cable 108 to be threaded through the pipe to be replaced first, without having to be concerned with which components were threaded through the cable 108 before the cable 108 is threaded through the pipe to be replaced. Operating in a pit is often messy and cramped. It is desirable to be able to assemble components for pipe removal or pipe bursting at different times in an operation by lateral insertion over the cable 108. Lateral insertion of various components also provides an option to switch or add different components without having to withdraw the cable 108 from the pipe to be replaced. For example, an end plate 131 of the splitting fixture 130 includes a vertical slot 133, and an optional retaining plate 142 includes another vertical slot 144.

The retaining plate 142 is shown adjacent to the soil stake plate 140. In the example shown, the retaining plate 142 includes a same or similar dimension with the end plate 131 of the splitting fixture 130. The retaining plate 142 can be used alternatively to the splitting fixture 130 for different types of pipe extraction, and the same or similar dimension facilities switching between the retaining plate 142 and the splitting fixture 130. In one example, the same or similar dimension incudes a plate width and/or a plate thickness that mates with a slot in the soil stake plate 140.

In one operation, it is desirable to pull a pipe to be replaced out of the ground for disposal. Examples of such an operation include, but are not limited to, lead pipe removal. In such an example, the splitting fixture 130 may be installed against the soil stake plate 140. In this example, a pipe to be replaced is allowed to pass through the vertical slot 143, and through the vertical slot 133 in the end plate 131, where it encounters a splitter 135 in the splitting fixture 130. The pipe to be replaced is split on the splitter, and can be removed from a pit and disposed of. This is especially desired with lead pipe, due to lead contamination issues.

In another operation, it is desirable for a pipe to be replaced to remain in the ground. A copper or polymer pipe can be left in the ground without contamination issues, and so it may be easier to split the pipe to be replaced and pull in a new pipe while the split pipe to be replaced is pushed aside into the soil. This type of operation is often referred to as pipe slitting or pipe bursting. With smaller diameter pipes, however, the pipe to be replaced may begin to partially pull out of the ground, even if pulling out of the ground is not desired. By using the retaining plate 142 instead of the splitting fixture 130 the pipe to be replaced will butt up against the retaining slot 144 while the cable is allowed through the retaining plate 142. In this way, the pipe to be replaced is held in the ground, while a splitter is drawn through the pipe to be replaced. An expander can be used to push the split pipe to be replaced into the surrounding soil while a new pipe is drawn into the space created after splitting the pipe to be replaced.

In another operation, a splitter is first drawn through a pipe to replaced to split the pipe, which facilitates loosening of the pipe within the surrounding soil. After loosening, a second length of cable is attached to a distal end of the pipe to be replaced, and the loosened pipe to be replaced is extracted from the ground.

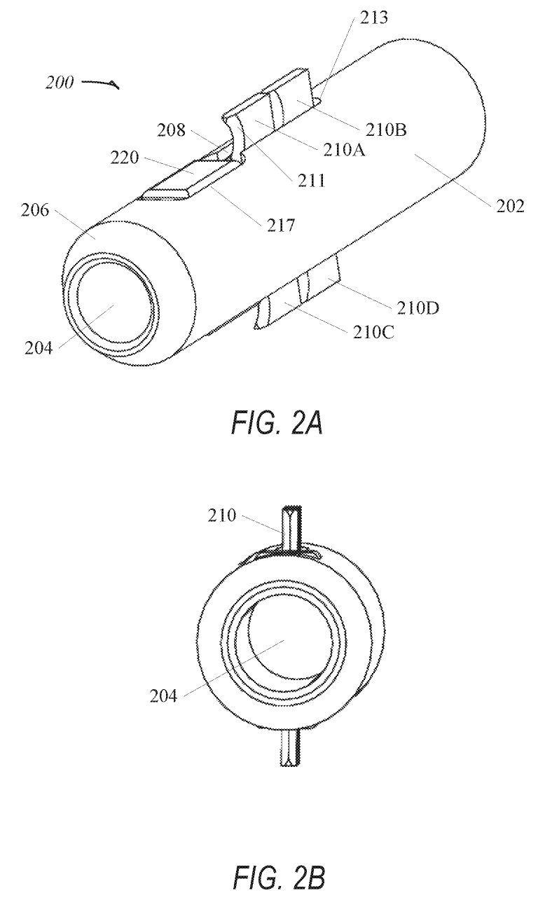

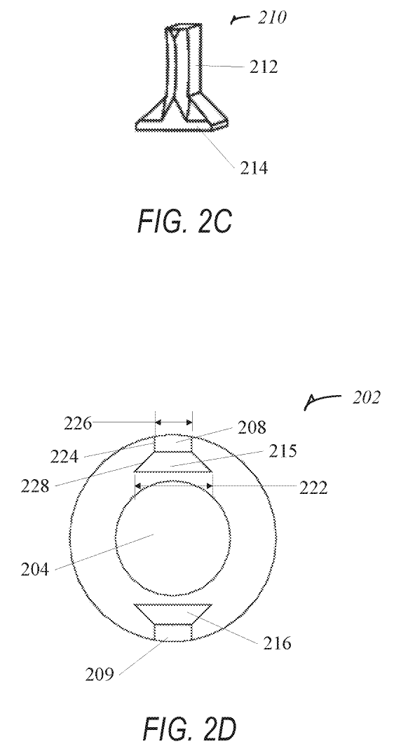

FIGS. 2A and 2B show views of a pipe splitter 200. The pipe splitter 200 can be used as described above, to split a pipe to be replaced where the pipe to be replaced remains in the ground. The pipe splitter 200 can also be used as described above, to loosen a pipe before subsequent extraction from the ground.

The pipe splitter 200 includes a splitter body 202. A longitudinal slot 208 is formed within the splitter body 202. In the example shown, the longitudinal slot 208 includes an entry pocket 217 at a first end of the longitudinal slot 208. A rear retaining wall 213 is shown at a second end of the longitudinal slot 208. In the example shown, the splitter body 202 includes multiple longitudinal slots, although the invention is not so limited. A single longitudinal slot may be used in one example, and more than two longitudinal slots may be used in other examples. FIG. 2A shows a second longitudinal slot on an opposing side of the splitter body 202 from the first longitudinal slot 208. This configuration facilitates splitting a pipe to be replaced into two separate portions. This makes extraction of the pipe from the ground easier if extraction is desired, as described in more detail below.

At least one replaceable cutter blade 210 is shown. A number of replaceable cutter blades 210A-210D are shown in FIG. 2A, although the invention is not so limited. In the example of FIG. 2A, four replaceable cutter blades 210A-210D are included with two replaceable cutter blades 210A-210B in a first longitudinal slot 208, and another two replaceable cutter blades 210C-210D in a second longitudinal slot 208. In the example shown, two replaceable cutter blades (for example, replaceable cutter blades 210A-210D) are aligned in series. In a splitting operation, it is advantageous to make cutter blades replaceable, as this facilitates replacement of broken or worn blades without have to replace an entire pipe splitter 200. By further including two replaceable cutter blades aligned in series, if a leading cutter blade 210A breaks off during a splitting operation, a redundant following cutter blade 210B is in place to ensure that a given splitting operation is completed.

In the example shown, the replaceable cutter blades 210A-210D are all gut hook shaped blades, each having a root 211 to cut a pipe to be replaced. In selected examples, some of the replaceable cutter blades 210A-210D may include different configurations from other replaceable cutter blades 210A-210D. For example, both gut hook blades and straight angled blades may be combined in selected examples.

Further, in the example of FIG. 2A, the following cutter blade 210B is dimensioned to only engage a pipe to be replaced if the leading cutter blade 210A is at least partially broken. This is in contrast to a splitter that may include multiple blades in line that increase progressively in size. When the following cutter blade 210B cutter blade is dimensioned to only engage a pipe to be replaced if the leading cutter blade 210A is at least partially broken, the following cutter blade 210B remains protected from damage until it is needed. The following cutter blade 210B will remain sharp and undamaged until it is exposed by breaking of the leading cutter blade 210A. Although two replaceable cutter blades are shown aligned in series, more than two replaceable cutter blades can also be implemented in series in other examples.

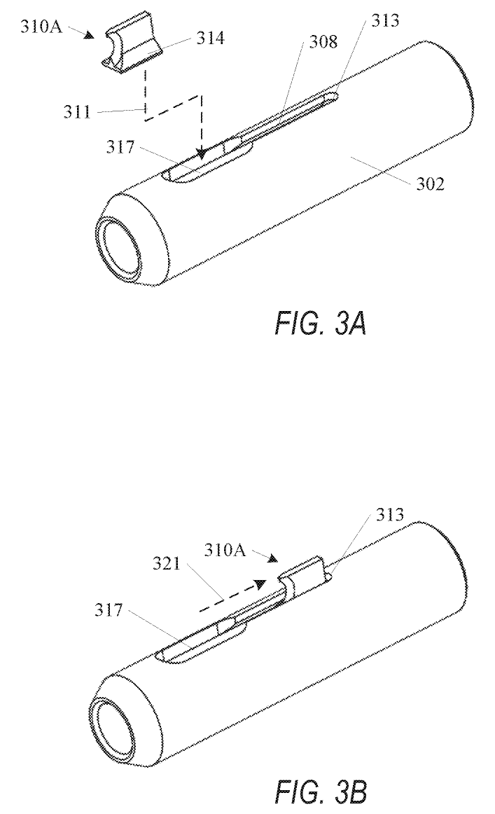

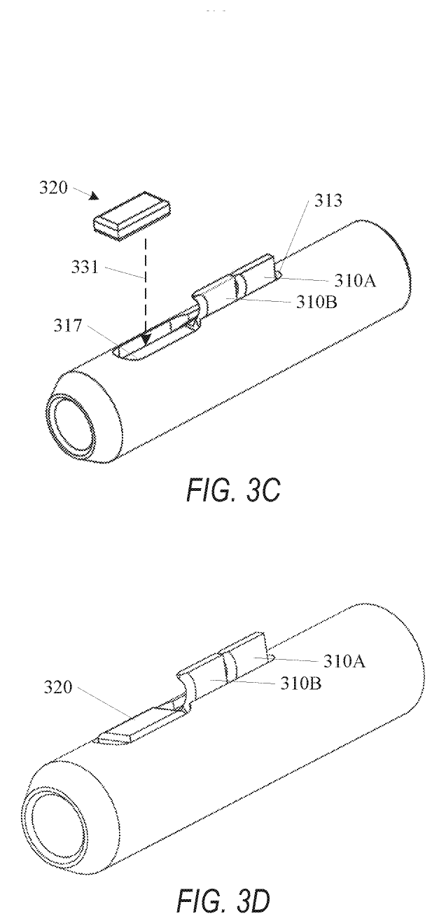

FIG. 2A further shows a removable front slot retainer 220 that fits within the entry pocket 217. Further details of the retention of replaceable cutter blades and the removable front slot retainer 220 are shown in FIGS. 3A-3D. In one example, the removable front slot retainer 220 includes a magnet. In one example, the removable front slot retainer 220 includes a neodymium alloy magnet, to provide a large magnetic force for a smaller given size of removable front slot retainer 220.

FIG. 2A further shows a leading taper 206 between a leading edge and an outer sidewall of the splitter body 202. It is advantageous to include a leading taper 206 to urge any soil or debris to the side of a cable that is used to pull the pipe splitter 200. The leading taper 206 may also help to expand a damaged pipe to be replaced, and to better align the pipe to be replaced before splitting on the replaceable cutter blades 210.

The illustration in FIGS. 2A and 2B show a hollow opening 204 that passes through an entire length of the splitter body 202. In one example, a swaged end on a cable is butted against a rear of the splitter body 202 after the cable passes through the hollow opening 204. In other examples, a coupling is included to anchor a cable to the splitter body 202. Examples of couplings are discussed in more detail in other examples discussed below.

FIG. 2C shows a replaceable cutter blade 210. The replaceable cutter blade 210 includes a foot 214 with a wider dimension than an upper blade 212. The foot 214 includes a geometry configured to engage a slot such as the longitudinal slot 208 discussed above. A cross section of the splitter body 202 is shown in FIG. 2D to further illustrate details of the longitudinal slot 208.

The longitudinal slot 208 of FIG. 2D includes a slot base 215 having a first width 222, and a lip 224 at an exterior of the longitudinal slot 208 defining a second width 226, smaller than the first width 222. In the example of FIG. 2D, the slot base 215 further includes a slot taper 228 that substantially matches a taper of the foot 214. Although a taper is shown as a matching geometry, other geometries between the foot 214 and the base 215 are within the scope of the invention. Examples include, but are not limited to, round geometries, oval geometries, rectangular geometries, etc. A taper 228 provides a transition between a bottom of the foot 214 and the upper blade 212 that reduces stress concentration points, and reduces a potential for cracking. A second slot 209 is further shown in FIG. 2D, the second slot 209 having a slot base 216 similar to slot base 215 of the longitudinal slot 208.

FIG. 3A-3D show an operation of assembling one or more replaceable cutter blades 310 into a longitudinal slot 308. In FIG. 3A, a first cutting blade 310A is placed into a pocket 317 in a side of a splitter body 302. The pocket 317 is located at a first end of the longitudinal slot 308, and a rear retaining wall 313 is located at a second end of the longitudinal slot 308. Placement of the first cutting blade 310 is indicated by arrow 311. The first cutting blade 310A includes a foot 314 that is dimensioned to fit radially into the pocket 317. The first cutting blade 310A is similar to the cutting blade 210 from FIGS. 2A-2D.

In FIG. 3B, after the first cutting blade 310A is within the pocket 317, the first cutting blade 310A is slid longitudinally into the longitudinal slot 308 as indicated by arrow 321. The first cutting blade 310A is retained within the longitudinal slot because of the foot 314 engaging a lip of the longitudinal slot. In FIG. 3C, a second cutting blade 310B is inserted into the pocket 317, then slid back against the first cutting blade 310A within the longitudinal slot 308. In the example shown in FIG. 3C, the first cutting blade 310A is dimensioned to only engage a pipe to be replaced if the second cutting blade 310B is at least partially broken.

A slot retainer 320 is further shown being inserted into the pocket 317 in FIG. 3C along dashed line 331. In one example, the slot retainer 320 includes a magnet to hold the slot retainer 320 within the pocket 317. By occupying a volume of the pocket 317, the cutting blades 310A, 310B are prevented from sliding back out of the longitudinal slot 308. In one example, the slot retainer 320 includes a magnet formed from a neodymium alloy. A neodymium magnet provides a stronger magnetic force than other magnets per unit volume of the slot retainer 320. The magnetic retaining force provided keeps the slot retainer 320 secure. Because the slot retainer 320 is recessed within the pocket, and is flush with an outer surface of the splitter body 302, the slot retainer tends to stay in place during a splitting operation. Forced from the splitting such as soil compaction forces will not affect the slot retainer 320 using the configuration shown in FIG. 3C. In one example, the slot retainer 320 includes the magnet, and a ferromagnetic material is included in the pocket 317 to provide attraction. In one example, the pocket 317 includes the magnet, and a ferromagnetic material is included in the slot retainer 320 to provide attraction.

Although a magnetic slot retainer 320 is described, the invention is not so limited. Other slot retainer 320 designs are within the scope of the invention. The slot retainer 320 may be secured with a screw, or other threaded fastener. The slot retainer 320 may be secured with an adhesive, where the adhesive strength may be overcome with a tool such as a screwdriver blade or other pry tool. A magnetic slot retainer 320 provides an advantage of being reusable, and because threaded fasteners are not used, there is no chance of threads becoming fouled with dirt or corrosion.

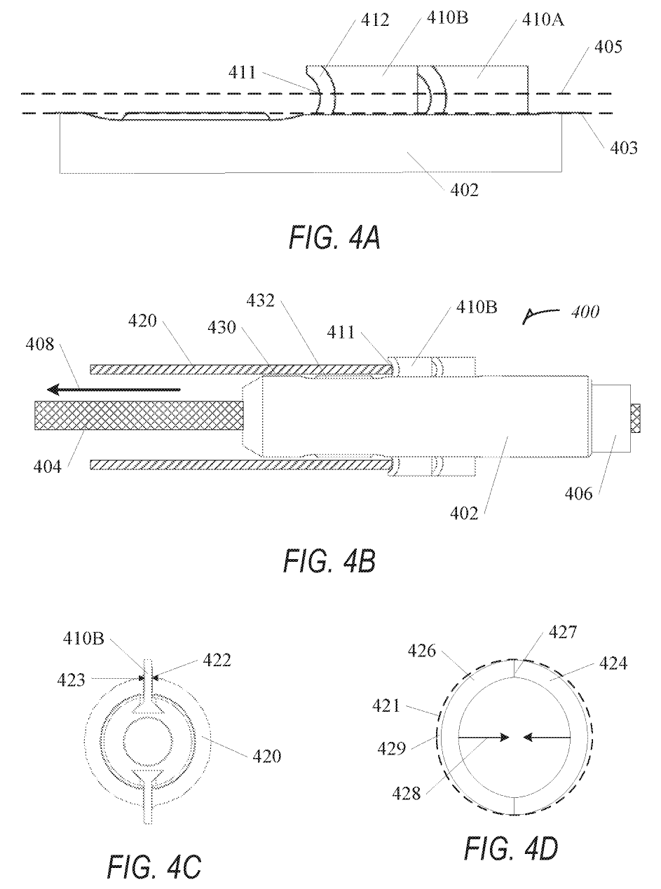

FIGS. 4A-4D illustrate a pipe splitter in use according to selected examples. In FIG. 4A, a portion of a splitter body 402 is shown. The splitter body 402 is similar to other splitter bodies described in examples above. A first cutting blade 410A and a second cutting blade 410B are shown. Similar to examples described above, in FIG. 4A, the first cutting blade 410A is dimensioned to only engage a pipe to be replaced if the second cutting blade 410B is at least partially worn or broken. In FIG. 4A, both cutting blades 410A, 410B include gut hook shaped cutting edges 412.

FIG. 4A further shows a root 411 of the gut hook cutting edge 412 is spaced apart from a sidewall of the splitter body 402. The sidewall of the splitter body 402 is indicated by first dashed line 403. The root 411 of the gut hook cutting edge 412 is indicated by second dashed line 405. The difference in spacing between the first dashed line 403 and the second dashed line 405 illustrates how the root 411 of the gut hook cutting edge 412 is spaced apart from a sidewall of the splitter body 402. In operation, this spacing provides a functional advantage. When a pipe to be replaced is being split, a sidewall of the pipe to be replaced will be pushed to center within the root 411 of the gut hook cutting edge 412. This tends to lower pressure, or even create a gap between a side of the splitter body 402 and the inner wall of the pipe to be replaced. In this way, friction between a side of the splitter body 402 and the inner wall of the pipe to be replaced is reduced.

FIG. 4B shows a pipe splitter 400 in operation splitting a pipe to be replaced 420. A sidewall of the pipe to be replaced 420 is engaging the root 411 of the second cutting blade 410B. A gap 430 (or low pressure region) is created adjacent to the second cutting blade 410B because of the location of the root 411 of the second cutting blade 410B. A magnetic slot retainer 432 is shown, within the gap 430. A cable 404 is shown pulling the pipe splitter 400 through the pipe to be replaced 420 as indicated by arrow 408. In the example of FIG. 4B, the cable 404 passes through a hollow central opening in the splitter body 402, and is retained by coupling 406 as it butts up against the splitter body 402.

In the example of FIG. 4B, the coupling 406 is attached to the cable 404, for example by swaging, or casting. In other examples, the coupling 406 is attached to the cable 404 using a collet or a tapered wedge configuration. Other cable securing devices are also within the scope of the invention. Although the coupling 406 shown in FIG. 4B is a separate component from the pipe splitter 400, other examples may include a cable securing coupling that is included as a component of the pipe splitter 400.

In FIG. 4C, a cross-section end-on view of the pipe to be replaced 420 being split is shown. The second cutting blade 410B is shown pushing a portion of the pipe to be replaced 420 out of the way as the cutter splits the pipe. The second cutting blade 410B is shown, having a cutter width 423. As the second cutting blade 410B passes through the pipe to be replaced 420 it necessarily displaces a portion of the pipe to be replaced 420. A deformed burr 422 of pipe material is shown pushed out of the space that is occupied by the cutter width 423.

In FIG. 4D, the space created by the cutter width 423 is shown allowing the pipe to be replaced 420 to collapse slightly, effectively loosening the pipe to be replaced 420. In FIG. 4D, the pipe to be replaced 420 has been split into a first part 424 and a second part 426. After splitting, the gap created by the cutter width 423 can collapse, and the first part 424 is allowed to move into the second part 426 as shown by arrows 428. After collapsing, as shown in FIG. 4D, the gap created by the cutter width 423 closes to form a contact region 427 between the first part 424 and a second part 426. As a result of the collapse of the gap, the first part 424 and a second part 426 move inward from an original cross section outline 421, creating a loosening gap 429 between the first part 424 and a second part 426 and the surrounding soil.

In this way, passing a pipe splitter as shown in the present disclosure through a pipe to be replaced will loosen the pipe to be replaced from the surrounding soil. In one example operation, the loosened pipe may then be extracted from the soil. In other examples a split pipe may be pushed aside and left within the ground as a new pipe is drawn into the space where the pipe to be replaced once was. It can be desirable to remove a pipe to be replaced from the ground entirely in some situations. One example includes lead pipe, which may contaminate soil if left in the ground.

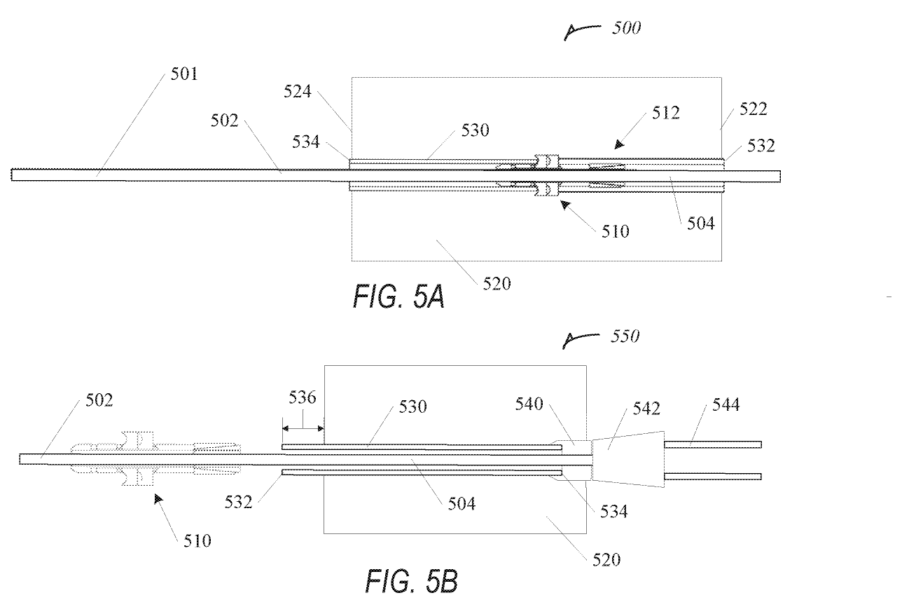

FIG. 5A and 5B further show one example operation of removing a pipe to be replaced from the ground. FIG. 5A shows a first stage 500 of a pipe removal operation. In FIG. 5A, a portion of ground 520 is shown. An entry edge 522 and an exit edge 524 are shown. Typically an entry edge 522 will be located in an entry pit, and an exit edge 524 will be located in an exit pit, although pits may not be used in all cases. A pipe to be replaced 530 is shown with a first end 532 substantially flush with the entry edge 522 and a second end 534 substantially flush with the exit edge 524. A cable 501 is shown threaded through the pipe to be replaced 530. In the example of FIG. 5A, the cable 501 includes a first cable portion 502 pulling a pipe splitter 510. A second cable portion 504 is shown being pulled into the pipe to be replaced 530 behind the pipe splitter 510. A coupling 512 is shown with a collet that grips the cable 501 behind the pipe splitter 510, dividing the cable 501 into the first cable portion 502 and the second cable portion 504.

In FIG. 5A, the pipe to be replaced 530 is split, however, the pipe to be replaced 530 remains in the ground 520. In one example, then pipe to be replaced 530 remains entirely as shown during the splitting operation with the first end 532 substantially flush with the entry edge 522 and the second end 534 substantially flush with the exit edge 524. In other examples, the force of splitting may partially remove the pipe to be replaced 530 from the ground towards the exit edge 524.

FIG. 5B shows a second stage 550 of the pipe removal operation. In FIG. 5B, the portion of ground 520 is shown. The pipe splitter 510 is shown removed from the ground 520 and still attached to the first cable portion 502, although the invention is not so limited. In FIG. 5B, the second cable portion 504 is attached to the second end 534 of the pipe to be replaced. In the example of FIG. 5B, a retainer 540 is used, the retainer including a recess that partially surrounds the second end 534 of the pipe to be replaced 530. Any device or technique to secure the second cable portion 504 to the second end 534 of the pipe to be replaced 530 is within the scope of the invention. The second cable portion 504 is then pulled and the pipe to be replaced 530 is shown exiting the ground 520. In FIG. 5B, the pipe to be replaced 530 has moved a distance 536 out of the ground as a result of pulling the second cable portion 504 and the retainer 540.

In the example shown, an expander 542 is further included behind the retainer 540. The retainer 540 and the expander 542 may be separate components, or they may be coupled together as a single component. A new pipe 544 is shown being pulled into place concurrently as the pipe to be replaced 530 is removed from the ground. In one example, the first stage 500 of FIG. 5A loosens the pipe to be replaced 530 as discussed in FIGS. 4A-4D. The second stage 550 of FIG. 5B then removes the loosened pipe to be replaced 530 from the ground.

Although a single continuous cable 501 is shown in the example of FIG. 5A and 5B, the invention is not so limited. In other examples two separate cables are used. A first cable may be used to perform the splitting operation shown in FIG. 5A, and a second cable may be used to perform the pipe removal operation shown in FIG. 5B. An advantage of using one continuous cable as described in the examples of FIGS. 5A and 5B includes only one threading operation for the cable through the pipe to be replaced.

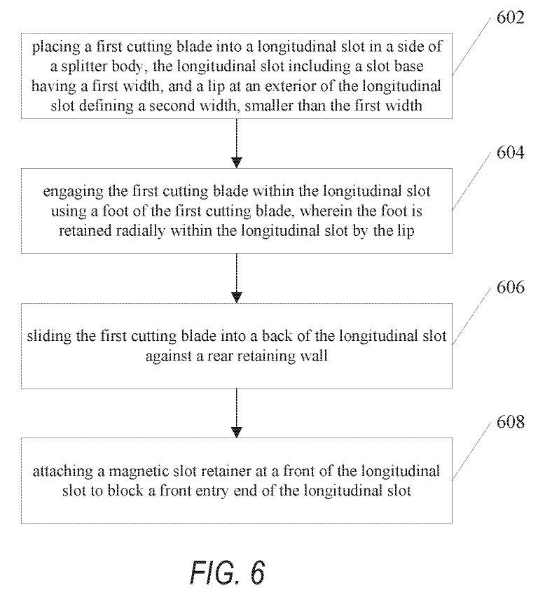

FIG. 6 shows a flow diagram of one example method of pipe splitting. In operation 602, a first cutting blade is placed into a longitudinal slot in a side of a splitter body. The longitudinal slot includes a slot base having a first width, and a lip at an exterior of the longitudinal slot defining a second width, smaller than the first width. In operation 604, the first cutting blade is engaged within the longitudinal slot using a foot of the first cutting blade. The foot is retained radially within the longitudinal slot by the lip. In operation 606, the first cutting blade is slid into a back of the longitudinal slot against a rear retaining wall. In operation 608, a magnetic slot retainer is attached at a front of the longitudinal slot to block a front entry end of the longitudinal slot.

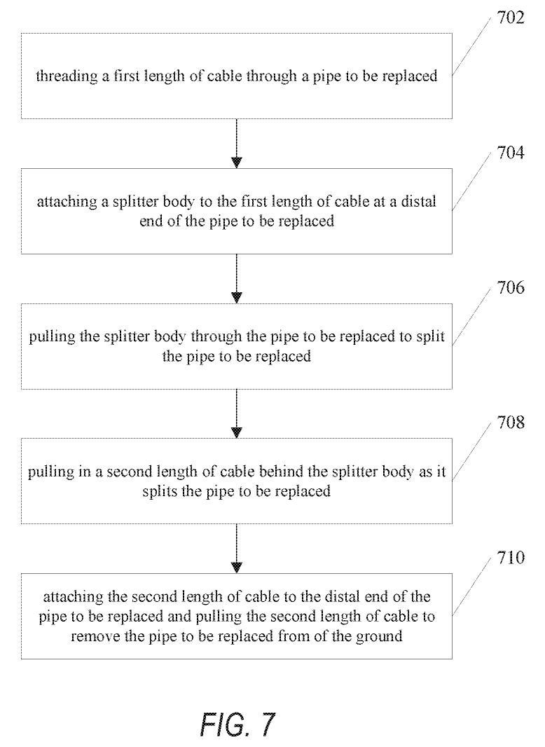

FIG. 7 shows another flow diagram of one example method of pipe splitting. In operation 702, a first length of cable is threaded through a pipe to be replaced. In operation 704, a splitter body is attached to the first length of cable at a distal end of the pipe to be replaced. In operation 706, the splitter body is pulled through the pipe to be replaced to split the pipe to be replaced. In operation 708, a second length of cable is pulled in behind the splitter body as it splits the pipe to be replaced. In operation 710, the second length of cable is attached to the distal end of the pipe to be replaced the second length of cable is pulled to remove the pipe to be replaced from of the ground.

To better illustrate the method and apparatuses disclosed herein, a non-limiting list of embodiments is provided here:

Aspect 1. A pipe splitter, comprising: a splitter body; a longitudinal slot in a side of the splitter body, the longitudinal slot including a slot base having a first width, and a lip at an exterior of the longitudinal slot defining a second width, smaller than the first width; an entry pocket at a first end of the longitudinal slot, and a rear retaining wall at a second end of the longitudinal slot; a replaceable cutter blade having a foot that fits radially into the entry pocket, then slides into the longitudinal slot, wherein the foot is retained radially within the longitudinal slot by the lip; a removable front slot retainer that fits within the entry pocket.

Aspect 2. The pipe splitter of aspect 1, wherein the replaceable cutter blade is one of two replaceable cutter blades aligned in series.

Aspect 3. The pipe splitter of aspect 1, wherein the longitudinal slot is a first longitudinal slot, and further including a second longitudinal slot on an opposing side of the splitter body from the first longitudinal slot.

Aspect 4. The pipe splitter of aspect 1, wherein the replaceable cutter blade includes a gut hook blade.

Aspect 5. The pipe splitter of aspect 4, wherein a root of gut hook blade is spaced apart from a sidewall of the splitter body.

Aspect 6. The pipe splitter of aspect 1, wherein the removable front slot retainer includes a magnet.

Aspect 7. The pipe splitter of aspect 6, wherein the magnet includes a neodymium alloy.

Aspect 8. The pipe splitter of aspect 1, wherein the splitter body is hollow to accept a cable.

Aspect 9. The pipe splitter of aspect 1, further including a coupling to anchor a cable on the splitter body.

Aspect 10. The pipe splitter of aspect 1, wherein the splitter body includes a leading taper between a leading edge and an outer sidewall of the splitter body.

Aspect 11. A pipe splitter, comprising: a splitter body; a longitudinal slot in a side of the splitter body; a first replaceable cutter blade in the longitudinal slot; a second replaceable cutter blade in the longitudinal slot behind the first replaceable cutter blade, wherein the second replaceable cutter blade is dimensioned to only engage a pipe to be replaced if the first replaceable cutter blade is at least partially broken.

Aspect 12. The pipe splitter of aspect 11, wherein the first replaceable cutter blade and the second replaceable cutter blade both includes gut hook blades.

Aspect 13. The pipe splitter of aspect 11, wherein the longitudinal slot includes a slot base having a first width, and a lip at an exterior of the longitudinal slot defining a second width, smaller than the first width.

Aspect 14. The pipe splitter of aspect 13, wherein the longitudinal slot includes an entry pocket at a first end of the longitudinal slot, and a rear retaining wall at a second end of the longitudinal slot.

Aspect 15. The pipe splitter of aspect 14, wherein the first replaceable cutter blade and the second replaceable cutter blade both include a foot that fits radially into the entry pocket, then slides into the longitudinal slot, wherein the foot is retained radially within the longitudinal slot by the lip.

Aspect 16. The pipe splitter of aspect 15, further including a removable front slot retainer that fits within the entry pocket.

Aspect 17. The pipe splitter of aspect 16, wherein the removable front slot retainer includes a magnet.

Aspect 18. A method of pipe splitting, comprising: placing a first cutting blade into a longitudinal slot in a side of a splitter body, the longitudinal slot including a slot base having a first width, and a lip at an exterior of the longitudinal slot defining a second width, smaller than the first width; engaging the first cutting blade within the longitudinal slot using a foot of the first cutting blade, wherein the foot is retained radially within the longitudinal slot by the lip; sliding the first cutting blade into a back of the longitudinal slot against a rear retaining wall; and attaching a magnetic slot retainer at a front of the longitudinal slot to block a front entry end of the longitudinal slot.

Aspect 19. The method of aspect 18, wherein attaching a magnetic slot retainer includes inserting the magnetic slot retainer radially into a pocket in a side of the splitter body.

Aspect 20. The method of aspect 18, further including placing a second cutting blade into the longitudinal slot to provide redundancy if one of the first cutting blade or second cutting blade fails.

Aspect 21. The method of aspect 18, further including threading a first length of cable through a pipe to be replaced and attaching the splitter body to the first length of cable at a distal end of the pipe to be replaced; pulling the splitter body through the pipe to be replaced to split the pipe to be replaced; and pulling in a second length of cable behind the splitter body as it splits the pipe to be replaced.

Aspect 22. The method of aspect 21, further including attaching the second length of cable to the distal end of the pipe to be replaced and pulling the second length of cable to remove the pipe to be replaced from of the ground.

Aspect 23. A method, comprising: threading a first length of cable through a pipe to be replaced; attaching a splitter body to the first length of cable at a distal end of the pipe to be replaced; pulling the splitter body through the pipe to be replaced to split the pipe to be replaced; pulling in a second length of cable behind the splitter body as it splits the pipe to be replaced; and attaching the second length of cable to the distal end of the pipe to be replaced and pulling the second length of cable to remove the pipe to be replaced from of the ground.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Although an overview of the inventive subject matter has been described with reference to specific example embodiments, various modifications and changes may be made to these embodiments without departing from the broader scope of embodiments of the present disclosure. Such embodiments of the inventive subject matter may be referred to herein, individually or collectively, by the term “invention” merely for convenience and without intending to voluntarily limit the scope of this application to any single disclosure or inventive concept if more than one is, in fact, disclosed.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

As used herein, the term “or” may be construed in either an inclusive or exclusive sense. Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present disclosure as represented by the appended claims. The specification and drawings are, accordingly, to be regarded in an illustrative rather than a restrictive sense.

The foregoing description, for the purpose of explanation, has been described with reference to specific example embodiments. However, the illustrative discussions above are not intended to be exhaustive or to limit the possible example embodiments to the precise forms disclosed. Many modifications and variations are possible in view of the above teachings. The example embodiments were chosen and described in order to best explain the principles involved and their practical applications, to thereby enable others skilled in the art to best utilize the various example embodiments with various modifications as are suited to the particular use contemplated.

It will also be understood that, although the terms “first,” “second,” and so forth may be used herein to describe various elements, these elements should not be limited by these terms. These terms are only used to distinguish one element from another. For example, a first contact could be termed a second contact, and, similarly, a second contact could be termed a first contact, without departing from the scope of the present example embodiments. The first contact and the second contact are both contacts, but they are not the same contact.

The terminology used in the description of the example embodiments herein is for the purpose of describing particular example embodiments only and is not intended to be limiting. As used in the description of the example embodiments and the appended examples, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” may be construed to mean “when” or “upon” or “in response to determining” or “in response to detecting,” depending on the context. Similarly, the phrase “if it is determined” or “if [a stated condition or event] is detected” may be construed to mean “upon determining” or “in response to determining” or “upon detecting [the stated condition or event]” or “in response to detecting [the stated condition or event],” depending on the context.

1. A pipe splitter, comprising:
a splitter body;
a longitudinal slot in a side of the splitter body, the longitudinal slot including a slot base having a first width, and a lip at an exterior of the longitudinal slot defining a second width, smaller than the first width;
an entry pocket at a first end of the longitudinal slot, and a rear retaining wall at a second end of the longitudinal slot;
a replaceable cutter blade having a foot that fits radially into the entry pocket, then slides into the longitudinal slot, wherein the foot is retained radially within the longitudinal slot by the lip;
a removable front slot retainer that fits within the entry pocket.

2. The pipe splitter of claim 1, wherein the replaceable cutter blade is one of two replaceable cutter blades aligned in series.

3. The pipe splitter of claim 1, wherein the longitudinal slot is a first longitudinal slot, and further including a second longitudinal slot on an opposing side of the splitter body from the first longitudinal slot.

4. The pipe splitter of claim 1, wherein the replaceable cutter blade includes a gut hook blade.

5. The pipe splitter of claim 4, wherein a root of gut hook blade is spaced apart from a sidewall of the splitter body.

6. The pipe splitter of claim 1, wherein the removable front slot retainer includes a magnet.

7. The pipe splitter of claim 6, wherein the magnet includes a neodymium alloy.

8. The pipe splitter of claim 1, wherein the splitter body is hollow to accept a cable.

9. The pipe splitter of claim 1, further including a coupling to anchor a cable on the splitter body.

10. The pipe splitter of claim 1, wherein the splitter body includes a leading taper between a leading edge and an outer sidewall of the splitter body.

11. A pipe splitter, comprising:
a splitter body;
a longitudinal slot in a side of the splitter body;
a first replaceable cutter blade in the longitudinal slot;
a second replaceable cutter blade in the longitudinal slot behind the first replaceable cutter blade, wherein the second replaceable cutter blade is dimensioned to only engage a pipe to be replaced if the first replaceable cutter blade is at least partially broken.

12. The pipe splitter of claim 11, wherein the first replaceable cutter blade and the second replaceable cutter blade both includes gut hook blades.

13. The pipe splitter of claim 11, wherein the longitudinal slot includes a slot base having a first width, and a lip at an exterior of the longitudinal slot defining a second width, smaller than the first width.

14. The pipe splitter of claim 13, wherein the longitudinal slot includes an entry pocket at a first end of the longitudinal slot, and a rear retaining wall at a second end of the longitudinal slot.

15. The pipe splitter of claim 14, wherein the first replaceable cutter blade and the second replaceable cutter blade both include a foot that fits radially into the entry pocket, then slides into the longitudinal slot, wherein the foot is retained radially within the longitudinal slot by the lip.

16. The pipe splitter of claim 15, further including a removable front slot retainer that fits within the entry pocket.

17. The pipe splitter of claim 16, wherein the removable front slot retainer includes a magnet.

18. A method of pipe splitting, comprising:
placing a first cutting blade into a longitudinal slot in a side of a splitter body, the longitudinal slot including a slot base having a first width, and a lip at an exterior of the longitudinal slot defining a second width, smaller than the first width;
engaging the first cutting blade within the longitudinal slot using a foot of the first cutting blade, wherein the foot is retained radially within the longitudinal slot by the lip;
sliding the first cutting blade into a back of the longitudinal slot against a rear retaining wall; and
attaching a magnetic slot retainer at a front of the longitudinal slot to block a front entry end of the longitudinal slot.

19. The method of claim 18, wherein attaching a magnetic slot retainer includes inserting the magnetic slot retainer radially into a pocket in a side of the splitter body.

20. The method of claim 18, further including placing a second cutting blade into the longitudinal slot to provide redundancy if one of the first cutting blade or second cutting blade fails.

21. The method of claim 18, further including threading a first length of cable through a pipe to be replaced and attaching the splitter body to the first length of cable at a distal end of the pipe to be replaced;
pulling the splitter body through the pipe to be replaced to split the pipe to be replaced; and
pulling in a second length of cable behind the splitter body as it splits the pipe to be replaced.

22. The method of claim 21, further including attaching the second length of cable to the distal end of the pipe to be replaced and pulling the second length of cable to remove the pipe to be replaced from of the ground.

23. A method, comprising:
threading a first length of cable through a pipe to be replaced;
attaching a splitter body to the first length of cable at a distal end of the pipe to be replaced;
pulling the splitter body through the pipe to be replaced to split the pipe to be replaced;
pulling in a second length of cable behind the splitter body as it splits the pipe to be replaced; and
attaching the second length of cable to the distal end of the pipe to be replaced and pulling the second length of cable to remove the pipe to be replaced from of the ground.
